(19) United States
(12) Patent Application Publication
(10) Pub. No.: US 2004/0057008 A1
(43) Pub. Date: Mar. 25, 2004

(54) Eyeglasses assembly with replaceable pad

(76) Inventor: Kuo-Tseng Lin, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/667,341

(22) Filed: Sep. 23, 2003

Related U.S. Application Data
(63) Continuation-in-part of application No. 10/233,655, filed on Sep. 4, 2002.

(51) Int. Cl. G02C 5/02

(52) U.S. Cl. 351/124

(57) ABSTRACT

A eyeglasses assembly with replaceable pad comprises a frame, a pad and lens. The frame and the lens form in one, and the frame has a nose-stand in the form of inverted V in the middle of eyeglasses assembly. The both sides of nose stand of frame has at least a pillar, respectively, connect to hole of frame. In the middle of pad also has an inverted V nose stand. The pad also has at least a flange. The nose-stand of pad connects to the hole of nose stand of frame, and so the flange of pad connects to hole of frame. Further, the invention provides a replaceable pad to combine frame or lens easily without any tool. Furthermore, the eyeglasses assembly of present invention is conveniently and pleasing to the eye for user.

### REFERENCE TO RELATED APPLICATION

This Application is a Continuation-in-Part of patent application ser. No. 10/233,655, filed Sep. 4, 2002, now pending.

### FIELD OF THE INVENTION

The present invention relatives to a eyeglasses assembly, especially, is made of both hard and soft materials. Further, the eyeglasses frame of present invention has replaceable and soft pad.

### BACKGROUND OF THE INVENTION

In generally, the eyeglasses assembly is made of soft and hard materials as one, like safety eyeglasses for industry, sunglasses, sport-eyeglasses, but the pad of eyeglasses cannot be replaced. If the pad wear and tear or for other uses, the pad cannot be replaced and shall be buy another ones. The eyeglasses with replaceable pad, in conventionally, has come off easily and joints not firm. It is uncomfortable for user wearing.

Therefore, as above described, the present invention provides an eyeglasses assembly has firm joints, comfortable for user wearing and pleasuring to eyes.

### SUMMARY OF THE INVENTION

The purpose of present invention provides the eyeglasses assembly, made of soft and hard materials. The pad of said eyeglasses assembly is made of soft materials, connect to frame of said eyeglasses with strong joints can firm and not has come off easily.

Further, the purpose of present invention provides the eyeglasses assembly has replaceable pad. The pad is made of soft materials and replaced easily. The pad and face can match well, like sharp nose with think pad, flat nose with thick pad, for more comfortable and beautiful.

Furthermore, the purpose of present invention provides an eyeglasses assembly having a replaceable pad for different color matching user dresses.

Furthermore, the purpose of present invention provides an eyeglasses assembly that has a frame and lens forming in one, or directly uses lens to combine a replaceable in place of the frame.

The eyeglasses of present invention, comprising a frame and a pad, the frame and lens form in one. The pad is made of soft materials, softer than frame. In the middle of said frame has a nose stand in the form of inverted V. The said nose stand has at least a pillar. The said frame has at least a hole. In the middle of the pad has an inverted V nose stand. The pad is inside the frame. The nose-stand of pad connects to the hole of frame. The hole of frame connects to the lump of pad.

Moreover, anther embodiment of the invention comprises lens and a pad. In the middle of said lens is an inverted V-type shape. The inverted V-type shape has at least a pillar. The lens has at least a hole. In the middle of the pad has an inverted V nose stand. The pad is onside the lens. The nose-stand of pad connects to the hole of lens. The hole of lens connects to the lump of pad.

For the purpose of illustrating the invention, there is shown in the drawings several forms that are presently preferred, it being understood.

### BRIEF DESCRIPTION OF THE DRAWINGS

FIG. 1 is a three-dimensional view illustrating the preferred embodiment of present invention;

FIG. 2 is a decompose view illustrating the preferred embodiment of present invention;

FIG. 3A is a front view illustrating the frame of the preferred embodiment of present invention;

FIG. 3B is a vertical view illustrating the frame of the preferred embodiment of present invention;

FIG. 4A is a front view illustrating the pad of the preferred embodiment of present invention;

FIG. 4B is a vertical view illustrating the pad of the preferred embodiment of present invention;

FIG. 5A is a front view illustrating the frame of another preferred embodiment of present invention;

FIG. 5B is a front view illustrating the pad of another preferred embodiment of present invention;

FIG. 6 is a three-dimensional view illustrating the third preferred embodiment in present invention another preferred embodiment of present invention;

FIG. 7 is a decompose view illustrating the FIG. 6 of present invention; and

FIG. 8 is a three-dimensional view illustrating another preferred embodiment of present invention

### DETAILED DESCRIPTION OF THE PREFERRED EMBODIMENTS

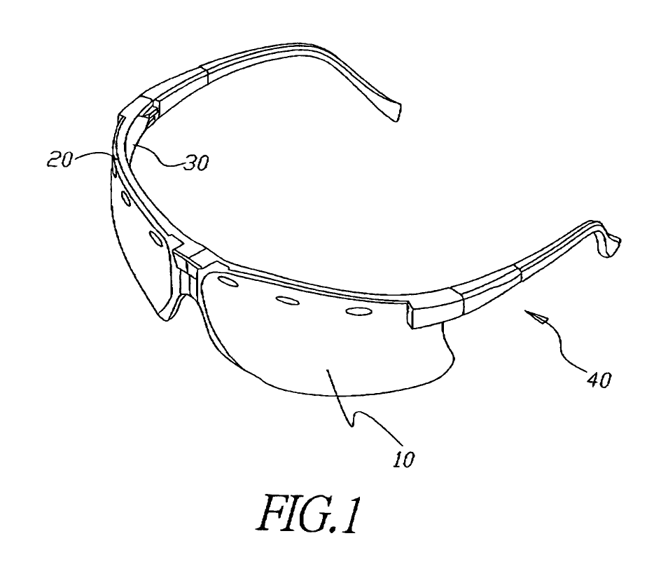

Reference to FIG. 1 is a three-dimensional view illustrating the preferred embodiment of present invention. The eyeglasses comprise a frame 20, a pad 30 inside the frame 20, and two legs 40 of eyeglasses connect to frame 20, respectively. A lens 10 and the frame 20 form in one.

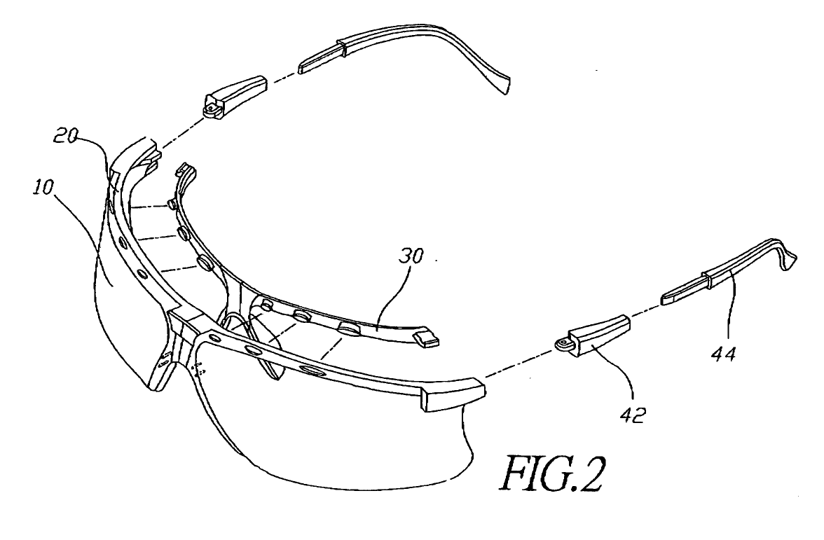

Reference to FIG. 2 is a decompose view illustrating the preferred embodiment of present invention. The eyeglasses comprising a frame 20, a pad 30 inside the frame 20, two front legs 42 connect to frame 20, respectively, two back legs 44 connect to two front legs 42, respectively, and a lens 10 and the frame 20 form in one.

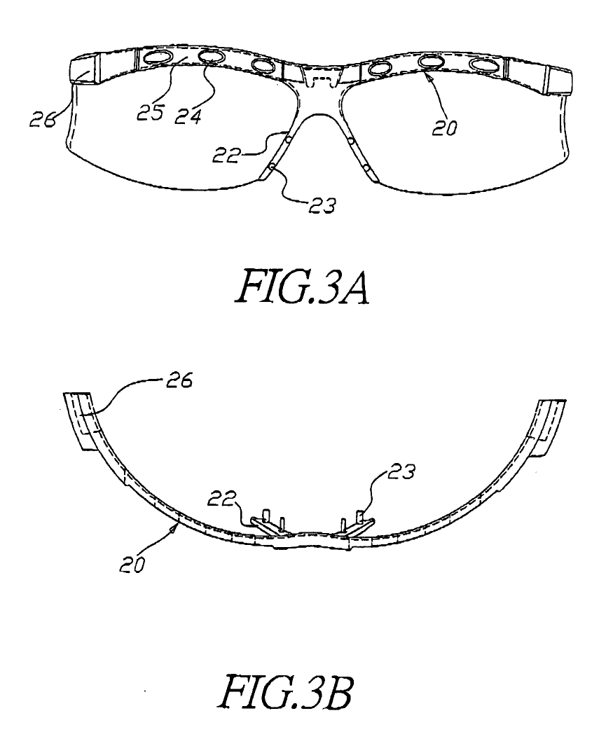

Reference to FIG. 3A and 3B show front and vertical views illustrating the frame of the preferred embodiment of present invention. In the middle of frame 20 has an inverted V nose stand 22. On the both sides of inverted V nose stand 22 have two pillars 23. There are six through holes 24 on the frame. Inside the frame 20 has a groove 25. On the both sides of frame 20 have a concave 26.

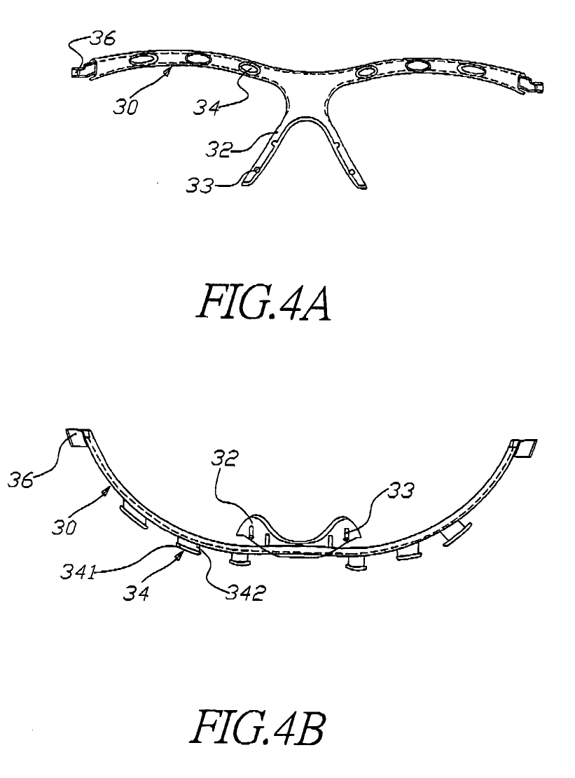

FIG. 4A and 4B show front and vertical views illustrating the pad 30 of the preferred embodiment of present invention. In the middle of pad 30 has an inverted V nose stand 32. On the both sides of inverted V nose stand 32 have two hold 33 connect to pillar 23 of frame 20. There are six lumps 34 in the pad 30 opposed to pillar 23 of frame 20, respectively. The lump 34 includes a front end 341 and a neck 342. The front end 341 is more expended then neck 342 for closing each other. Two ends of pad 30 has an infixed-flange 36 connect to a groove 26 of frame 20.

The present invention provides the frame 20 has a pillar 23 to connect insert-hole 33 and the hole 24, then, match to the lump 34 of pad 30 and so the groove 26 connect to the infixed-flange 36. The thick and width of pad 30 match to groove 25. Then, both sides of the nose stand 32 of pad 30 overlay the both sides of the nose stand 22 of frame 20 tightly and firm. The pad 30 can be exchangeable, to matching different face, like sharp nose fit think pad, flat nose fit thick pad, even can be change different colors to increase practicability. For user, the exchangeable pad can be more comfortable and beautiful.

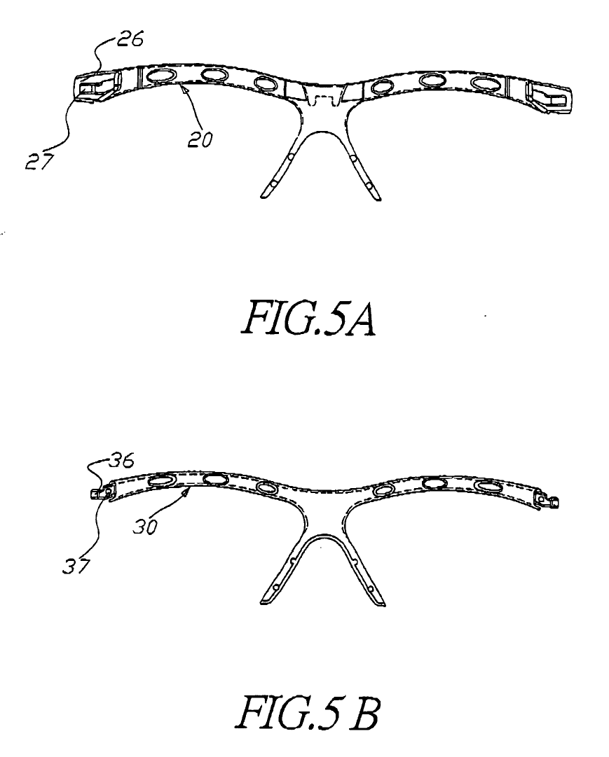

Reference to FIG. 5A and FIG. 5B show a front view illustrating the frame and the pad of another preferred embodiment of present invention. The character of the embodiment as FIG. 5A and FIG. 5B is two ends of frame 20 have a respective concave 26 with a respective connect-pillar 27. The infixed-flange 36 of pad 30 connect to connect-pillar 27 via connect-hole 37 on connect-pillar 27. As above described, the invention of present embodiment increase the intensity of connection, especially for low friction coefficient materials to make eyeglasses.

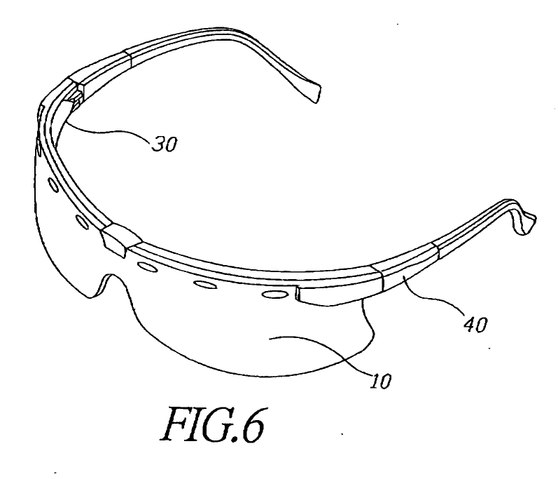

Reference to FIG. 6 is a three-dimensional view illustrating another preferred embodiment of present invention. The eyeglasses comprise a lens 10, a pad 30 inside the lens 10, and two legs 40 of eyeglasses connect to lens 10, respectively.

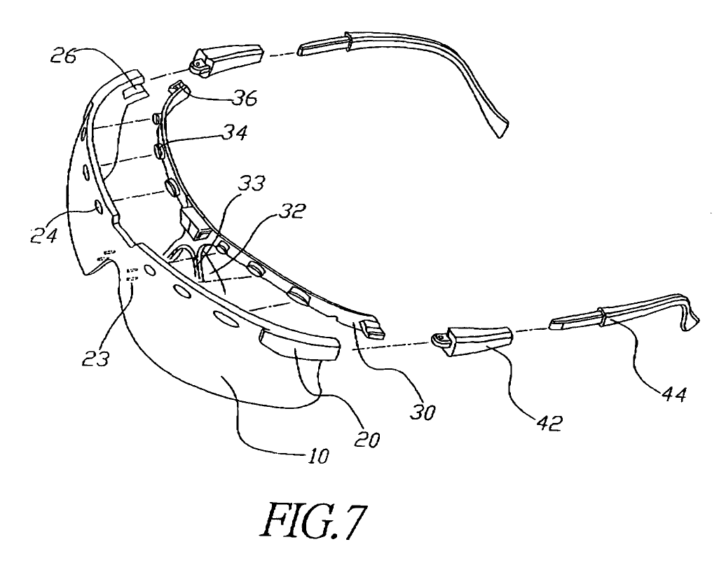

Reference to FIG. 7 is a decompose view illustrating the FIG. 6 of present invention. The eyeglasses comprising a lens 10, a pad 30 inside the lens 10, two front legs 42 connect to lens 10, respectively, and two back legs 44 connect to two front legs 42. In the middle of lens 10 is an inverted V type shape. On the both sides of inverted V type shape have two pillars 23. There are six through holes 24 on the top side of the lens 10. Inside the lens 10 has a groove 25. On the both sides of lens 10 have a concave 26. The structure of pad 30 is same as the FIG. 4A and FIG. 4B, so no more redundant words are described herein.

Thus, the present invention provides the lens 10 has a pillar 23 to connect insert-hole 33 and the hole 24, then, match to the lump 34 of pad 30 and so the groove 26 connect to the infixed-flange 36. The thick and width of pad 30 match to groove 25. Then, both sides of the nose stand 32 of pad 30 overlay the both sides of the middle of the lens 10 tightly and firm. The pad 30 can be exchangeable, to matching different face, like sharp nose fit think pad, flat nose fit thick pad, even can be change different colors to increase practicability. For user, the exchangeable pad can be more comfortable and beautiful.

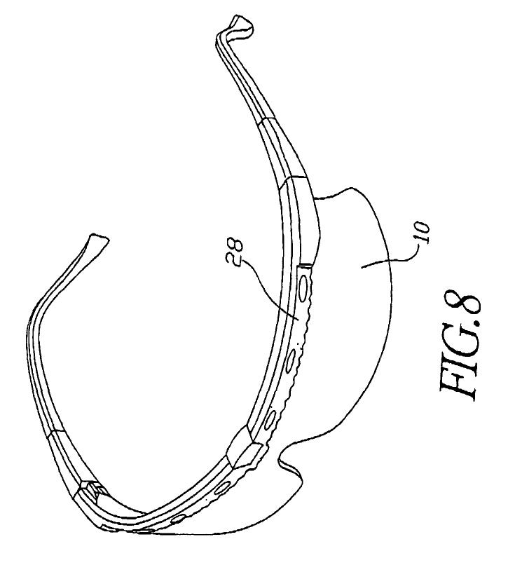

Except the eyeglasses assembly shown in the FIG. 1 and FIG. 6, the present invention also discloses other embodiments. Referring to the FIG. 8, it is a three-dimensional view illustrating the third preferred embodiment of present invention. Wherein, a pattern 28 is further provided on top side of the lens 10 as a like-frame 28. Other structure is same as the FIG. 6, so no more redundant words are described herein.

While there have been illustrated and described particular embodiments of the present invention, it will be appreciated that numerous changes and modifications will occur to those skilled in the art, and it is intended in the appended claims to cover all those changes and modifications which fall within the true spirit and scope of the present invention.

What is claimed is:

1. A eyeglasses assembly with replaceable pad, comprising:
a frame having a inverted “V” type nose stand and a hole, wherein said inverted V nose stand is in the middle of the frame, said hole on said frame, both sides of said inverted “V” type nose stand individually have at least one pillar, and said frame and lens form in one; and
a soft pad, placing inside of said frame, having a nose stand in opposite said inverted V nose and at least one insert hole connecting to said pillar, and said pad in opposite hole of said frame having a flange connecting to said hole of frame.

2. The eyeglasses assembly with replaceable pad as claimed in claim 1, wherein said frame has a concave on both sides.

3. The eyeglasses assembly with replaceable pad as claimed in claim 2, wherein said concave connects to infixed-flange on both sides of pad.

4. The eyeglasses assembly with replaceable pad as claimed in claim 3, wherein said both sides of frame has a groove connecting to the connect-pillar.

5. The eyeglasses assembly with replaceable pad as claimed in claim 4, wherein said connect-pillar on both sides of pad connects the connect-hole on infixed-flange on pad.

6. The eyeglasses assembly with replaceable pad as claimed in claim 1, wherein said frame has a groove inside.

7. The eyeglasses assembly with replaceable pad as claimed in claim 6, wherein said groove and pad match well on width and thick.

8. The eyeglasses assembly with replaceable pad as claimed in claim 1, wherein said nose stand of pad overlay the nose stand of frame.

9. The eyeglasses assembly as claimed in claim 1, wherein said flange of pad includes a flange front end and neck, the front end is more protruded then neck.

10. A eyeglasses assembly with replaceable pad, comprising:
a lens having a inverted “V” type shape in the middle of the lens and a hole, wherein said hole is on both top side of said lens, both sides of said lens of inverted “V” type shape individually have at least one pillar; and
a soft pad, placing inside of said lens, having a nose stand in opposite said inverted V nose and at least one insert hole connecting to said pillar, and said pad in opposite hole of said lens having a flange connecting to said hole of lens.

11. The eyeglasses assembly with replaceable pad as claimed in claim 10, wherein said lens has a concave on both sides.

12. The eyeglasses assembly with replaceable pad as claimed in claim 11, wherein said concave connects to infixed-flange on both sides of pad.

13. The eyeglasses assembly with replaceable pad as claimed in claim 12, wherein said both sides of lens have a groove connecting to the connect-pillar.

14. The eyeglasses assembly with replaceable pad as claimed in claim 13, wherein said connect-pillar on both sides of pad connects the connect-hole on infixed-flange, on pad.

15. The eyeglasses assembly with replaceable pad as claimed in claim 11, wherein said flange of pad includes a flange front end and neck, the front end is more protruded then neck.

16. The eyeglasses assembly with replaceable pad as claimed in claim 11, wherein a pattern is further provided on said top side of lens as a like-frame.
